(19) United States
(12) Patent Application Publication
(10) Pub. No.: US 2007/0170020 A1
(43) Pub. Date: Jul. 26, 2007

(54) Floating-caliper disk brake, especially for high braking power

(75) Inventors: Georg Halasy-Wimmer, Markgroningen (DE); Joachim Rehm, Frankfurt/M (DE); Andreas Pohlmann, Eschborn (DE); Peter Schack, Seligenstadt (DE); Stefan Johannes Schmitt, Eltville (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/589,297

(22) PCT Filed: Feb. 11, 2005
(86) PCT No.: PCT/EP05/50615

§ 371 Date: Aug. 14, 2006

(30) Foreign Application Priority Data
Feb. 13, 2004 (DE) 102004007474.7
Apr. 8, 2004 (DE) 102004018090.3

(51) Int. Cl. F16D 65/14

(52) U.S. Cl. 188/73.43

(57) ABSTRACT

Disclosed is a floating caliper disk brake for motor vehicles capable of developing high braking power. To realize a floating-caliper disk brake of high rigidity and heat resistance together with light weight at the same time, the brake comprises a frame-like floating caliper (1, 41), which projects over a brake disk (2) and the brake pads (3, 4) on both sides of the brake disk (2), the caliper being supported with freedom of movement by means of pin guides (14, 57) on a component (15) permanently attached to the vehicle. The frame-like floating caliper (1, 41) is formed by an inner caliper section (5, 45), which has at least one actuating device (12, 52), and by one outer caliper section (6, 46), which is connected to the inner caliper section (5, 45) by means of at least two bridge sections (7, 47), which project over the brake disk (2). The caliper sections (5,6; 45, 46) have a lattice-like, light-weight structure of high rigidity.

### BACKGROUND OF THE INVENTION

The present invention pertains to a floating-caliper disk brake for motor vehicles capable in particular of developing high braking power. These types of high-performance brakes are used in high-horsepower motor vehicles, for example, and also in the field of auto racing.

A fixed-caliper brake for high-horsepower motor vehicles is known from, for example, EP 1 016 804 A1. The fixed-caliper brake described here has hydraulic actuating devices on both sides of the brake disk; each device has a corresponding brake piston, which cooperates with the associated brake pad. This makes it possible to produce high brake clamping forces, which allow high levels of braking power to be reached. High braking power leads to high operating temperatures within the fixed-caliper brake and/or in the brake fluid. One of the reasons for this is that the brake fluid passes relatively close by the hot components of the fixed-caliper brake, e.g., the brake disk and the brake pads. High brake caliper or brake fluid temperatures, however, can cause the braking power to decrease, which is undesirable. Therefore, the fixed-caliper brake has a device for cooling the brake to reduce the operating temperatures. This device causes a stream of cooling air to pass through the fixed caliper. Overall, the fixed-caliper brake with the device for brake cooling is very heavy, which is extremely undesirable, especially for race car applications.

DE 196 22 209 A1, furthermore, describes a floating-caliper disk brake for a motor vehicle. This brake has a frame-like floating caliper, which is supported with a certain freedom of movement by means of pin guides on a brake holder, which is permanently attached to the vehicle. The brake holder has two holder arms which project over the associated brake disk, and the brake pads, mounted on both sides of the brake disk, are guided on the holder arms with a certain freedom of movement in the axial direction but are supported in the circumferential direction. The frame-like floating caliper projects over the friction pairing formed by the brake pads and the brake disk and takes care of introducing the necessary brake clamping force. Although the floating-caliper disk brake is able to develop high braking power, this design requires appropriately designed components of considerable weight.

Proceeding on this basis, the task of the invention is to provide a motor vehicle brake, especially for high braking power, which is superior to the known arrangements with respect to mechanical and thermal load capacity and also with respect to overall weight.

### SUMMARY OF THE INVENTION

This task is accomplished by a floating-caliper disk brake for motor vehicles with a frame-like floating caliper, which projects over a brake disk and the brake pads, one of which is located on each side of the disk, and which is supported with a certain freedom of movement by means of pin guides on a component permanently attached to the vehicle. The frame-like floating caliper comprises an inner caliper section, which has at least one actuating device, and an outer caliper section, which is connected to the inner caliper section by means of at least two bridge sections, which project over the brake disk. It is conceivable that the actuating device could, for example, be operated hydraulically or electrohydraulically, by means of an electric motor, or perhaps purely by electrical energy. To reduce weight, at least the two sections of the caliper have a light-weight, lattice-like structure, as a result of which the entire frame-like floating caliper also becomes extremely rigid, which is advantageous. In detail, each caliper section consists of several rib elements, web elements, and/or cylinder elements. The caliper section is preferably designed in a manner similar to that of a double-T beam to ensure a high degree of rigidity. Simultaneously, the lattice-like structure makes it easier for cooling air to pass through the caliper sections and thus guarantees reliable brake operation even at high operating temperatures. This is achieved preferably by providing the outer caliper section with at least one cooling channel to allow cooling air to flow to the outer brake pad. A cooling channel of this type can be formed, for example, by a cylindrical element or by an element of the lattice-like, light-weight structure functioning in an equivalent manner.

An advantageous embodiment of the floating-caliper disk brake is obtained in that at least the outer brake pad is attached permanently to the caliper, and thus basically follows the movement of the caliper when the brake is actuated. The floating caliper is supported tangentially against the component attached to the vehicle so that it can transmit circumferential forces. This means that the circumferential braking forces acting on the brake pad which is in the axially outer position with respect to the vehicle are introduced via the floating caliper into a component which is permanently attached to the vehicle.

According to an effective variant of the floating-caliper disk brake, the actuating device comprises a movable actuating element, the guide length of which inside the actuating device is greater than the sum of the maximum wear value of both brake pads and the maximum wear value of both sides of the disk brake. Because of the way in which the floating caliper is arranged, the guide length for the actuating element must be large enough to take into account the frictional wear of the brake pads and of both sides of the brake disk. This is important especially in the case of high-performance brakes, in which a great deal of frictional wear occurs. A long guide length ensures that the actuating element will still be guided reliably in the associated actuating device even after the brake pads have undergone significant amounts of wear. The actuating element is designed, for example, as a brake piston, such as those used, for example, in disk brakes with hydraulic actuating devices. The long guide length of the actuating element also makes sure that there is a wide gap between the temperature-sensitive actuating device and the components of the brake which are usually subjected to severe thermal loads such as the brake pads and the brake disk. This is important especially in the case of hydraulic or electrohydraulic actuating devices with their temperature-sensitive brake fluid.

An additional increase in the rigidity of the floating caliper can be achieved by designing at least one of the bridge sections as a central web, which connects the two caliper sections to each other in the area of the actuating device. For weight reasons, this central web is narrower than the bridge sections adjacent to it in the circumferential direction. It is these adjacent bridge sections together with the two caliper sections which form the actual frame-like structure of the floating caliper. Nevertheless, the central web contributes significantly to the rigidity of the frame-like floating caliper. Depending on the embodiment, several bridge-like webs can be provided.

According to a first advantageous embodiment of the floating-caliper disk brake, a brake holder permanently attached to the vehicle is provided. The arms of the holder project into the frame-like floating caliper and extend as far as the brake disk only on the inside. The floating caliper is mounted on the brake holder with a certain freedom of movement. The brake holder can be designed as a separate component, which is preferably fastened to the stub axle or to the wheel carrier of the motor vehicle, or it can be integrated directly into the stub axle or wheel carrier. In detail, the brake holder is designed in such a way as to minimize its weight, for which reason it does not project axially over the brake disk. The arms of the holder which project into the frame-like floating caliper, furthermore, are preferably U-shaped. Alternatively, it is conceivable that, to increase the mechanical load-bearing capacity, the arms of the brake holder could have a closed shape instead of a U-shape. In either case, it is advisable for the brake pad on at least one side of the brake disk to be supported tangentially on the brake holder to allow the transmission of circumferential braking forces. According to an elaboration of this first embodiment of the floating-caliper disk brake, the floating caliper is not only supported with freedom of axial movement on the brake holder but also supported tangentially on the arms of the brake holder to allow the transmission of circumferential forces. Any circumferential braking forces which occur can thus be introduced by the floating caliper directly to the brake holder, which is permanently attached to the vehicle.

To improve the guidance of the floating caliper during its axial movement on the brake holder, each pin guide has a guide pin, which is attached to the caliper sections of the floating caliper and supported with freedom of movement in the brake holder. In general, the guide pins are intended to transmit little if any of the circumferential braking force. This means that the guide pins can be very slender, since their most important function is obviously merely to guide the axial movement of the floating caliper. In detail, each of the guide pins is preferably connected detachably to the caliper sections by screws and accommodated within an associated bore in the brake holder, in which it is free to slide back and forth. Thus, when the brake is actuated, the guide pins move along with the floating caliper relative to the brake holder. In addition, it is advisable for the guide pins to connect the two caliper sections to each other in the manner of tension rods. This increases the rigidity of the floating caliper even more.

Yet another advantageous variant of the pin guide system is obtained in that the guide pins are provided with a suitable, long-lasting surface coating or surface treatment, especially a diamond-like coating, an electroplated nickel coating, a ceramic coating, or a cermet coating, to protect the pins from the effects of temperature and other environmental influences. This prevents the material which has been worn off the brake pads (brake dust) or high brake operating temperatures, for example, from interfering with the freedom of movement of the floating caliper in its guide.

According to a second preferred embodiment of the floating-caliper disk brake, at least one pin guide has a support pin for the transmission of circumferential forces. A support pin of this type acts directly between the floating caliper and a component attached to the vehicle; in particular, the support pin is attached to a component which is permanently attached to the vehicle and is supported with a certain freedom of movement in an associated bore in the floating caliper. Circumferential braking forces proceeding from the floating caliper can therefore be introduced directly via the support pin to the component such as the wheel carrier or the stub axle which is attached to the vehicle. There is no need in principle for a brake holder in the intermediate position. If the brake holder is eliminated, the brake pads on both sides of the brake disk will be supported tangentially in the floating caliper so that they can transmit the circumferential braking forces. According to an advantageous variant of the floating-caliper disk brake, at least the brake pad situated axially on the inside (with respect to the axis of the associated brake disk) is guided with a certain freedom of movement on at least one central web. This brake pad cooperates with the actuating device and is thus able to move in relation to the floating caliper. It is very easy to mount the brake pad movably on the central web, because little or no modification of the floating caliper is required.

### BRIEF DESCRIPTION OF THE DRAWINGS

Additional effective individual features of the invention can be derived from the exemplary embodiments illustrated in the figures, which are explained in greater detail below:

FIG. 1 shows a 3-dimensional view of a first exemplary embodiment of an inventive floating-caliper disk brake; and

FIG. 2 shows a 3-dimensional view of a second exemplary embodiment of an inventive floating caliper.

### DETAILED DESCRIPTION OF THE DRAWINGS

The exemplary embodiments of floating-caliper disk brakes shown in the figures are suitable for many purposes, including the application of high braking power. For this purpose, a frame-like floating caliper 1, 41 is provided, which is designed specifically for high braking power. The caliper is supported on a component permanently attached to the vehicle, such as a stub axle or a wheel carrier, in such a way that it retains a certain freedom of movement. A component permanently attached to the vehicle is not shown in the figures. The frame-like floating caliper 1, 41 projects over an associated brake disk 2 and the brake pads 3, 4, one of which is mounted on each side of the brake disk 2. The floating caliper 1, 41 is formed essentially by two caliper sections 5, 6; 45, 46, each of which extends in the direction of a secant along one side of the brake disk, and by two bridge sections 7, 47, which are located at the circumferential ends of the caliper and which project axially over the associated brake disk 2. The bridge sections 7, 47 connect the two caliper sections 5, 6; 45, 46 to each other. In addition to the bridge sections 7, 47 at the ends, it is also possible, depending on the concrete application, to provide at least one central bridge-like web 8, 48, which also connects the caliper sections 5, 6; 45, 46 to each other and which thus helps to increase the rigidity of the caliper.

Overall, the floating calipers 1, 41 shown in the figures are designed in all respects to have high rigidity and low weight at the same time. For example, the caliper sections 5, 6; 45, 46 all have a lattice-like, light-weight structure. According to that principle, the caliper sections 5,6; 45, 46 are built up primarily out of struts 9, 49; ribs 10, 50; and cylinder elements 11, 51. As a result, the caliper sections 5, 6; 45, 46 acquire a lattice-like, light-weight structure similar to that of a double-T beam, which is very rigid even though light in weight. The high rigidity of the caliper sections 5, 6; 45, 46 is responsible for advantageously uniform pressure conditions at the brake pads 3, 4 when the brake is actuated, even when the brake clamping forces are high. This leads to a uniform, parallel wear pattern, especially in the case of the brake pad located in the axially outer position with respect to the vehicle. In addition, the lattice-like, light-weight structure makes it easier for cooling air to flow around the floating caliper 1, 41, as a result of which high operating temperatures in the brake can be more rapidly lowered. This is achieved preferably by providing the outer caliper section 6, 46 with at least one cooling channel 11, 51 to allow cooling air to flow to the outer brake pad 4. A cooling channel 11, 51 of this type can be formed by, for example, a cylindrical element 11, 51 or by an element of the lattice-like, light-weight structure of equivalent effect. In the present exemplary embodiments, several cylindrical elements 11, 51 form the cooling channels 11, 51, each of these cooling channels passing axially through the outer caliper section 6, 46.

To actuate the floating-caliper disk brake, at least one actuating device 12, 52 is provided in the caliper section 5, 45 located axially on the inside with respect to the vehicle. This actuating device acts on the axially inner brake pad 3. So that higher brake clamping forces and thus also higher braking power can be achieved, it is advisable to use several such actuating devices. In principle, any desired type of actuating device can be used, e.g., electrical, electromechanical, electric motor-driven, electrohydraulic, or purely hydraulic. Hydraulic actuating devices are characterized by their higher power density.

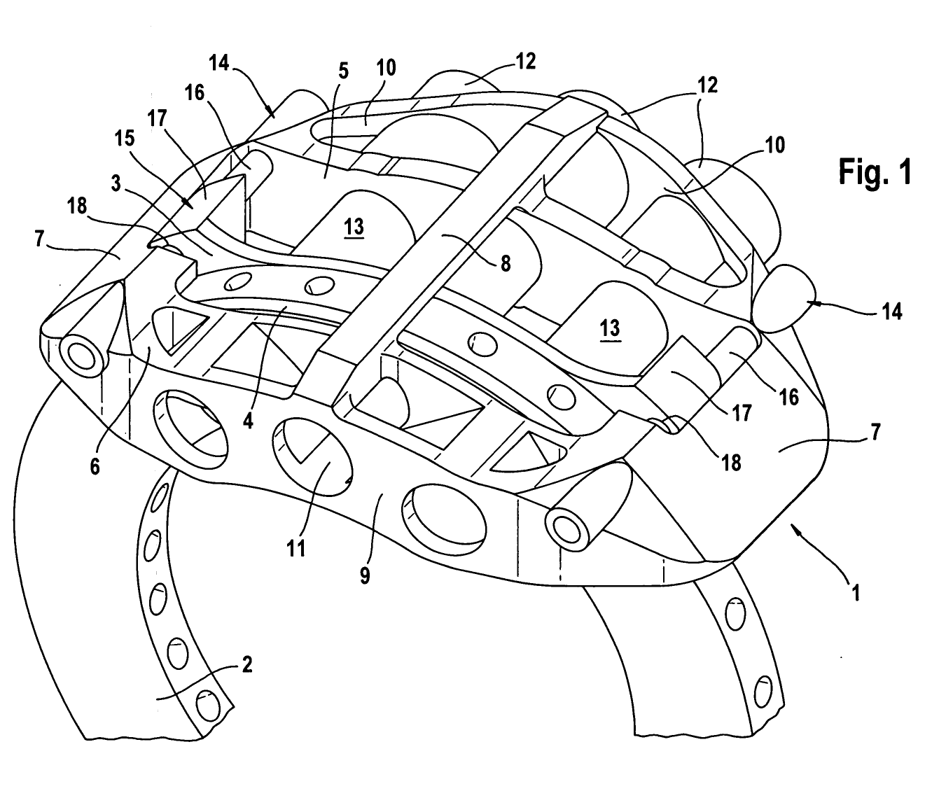

According to the first embodiment of the floating-caliper disk brake shown in FIG. 1, the floating caliper 1 has three hydraulic actuating devices 12 in the caliper section 5 located on the inside relative to the vehicle. These devices act on the inner brake pad 3 by way of brake pistons 13, which are mounted in such a way that they can move back and forth. Because all of the actuating devices 12 are located on the same side of the brake disk 2, the guide length of the brake piston 13 must allow for the entire wear value of both brake pads 3, 4 and of both sides of the brake disk. The brake piston must therefore be long enough to ensure that each brake piston 13 will still be reliably held in its actuating device 12 even after the brake pads 3, 4 have undergone considerable wear. At the same time, providing the brake piston with a sufficiently long guide length prevents the possibility of leaks in the hydraulic brake circuit. The length of the brake piston, which is much longer than that of known arrangements, also guarantees that the temperature-sensitive brake fluid will be farther away in space from the brake disk 2 and the brake pads 3, 4, which become very hot during operation. FIG. 1 shows a floating-caliper disk brake with very heavily worn brake pads 3, 4 and a worn brake disk 2, so that almost the entire guide length of the individual brake pistons 13 is called into play. The orientation of the cup-like brake pistons 13 with their closed ends directed toward the center of vehicle also ensures that all of the brake fluid present in the floating caliper 1 is subjected to an optimal flow of cooling air. This is responsible for a decisive advantage over known high-performance brakes of the fixed-caliper design, in which the outer caliper areas are poorly accessible to cooling media. In contrast, the present frame-like floating caliper 1 makes it possible to achieve a significant lowering of the brake fluid temperature.

The axially movable guidance of the floating caliper 1 with respect to a component permanently attached to the vehicle as required for the actuation of the brake is ensured by two pin guides 14, which act between a component attached to the vehicle and the floating caliper 1. A brake holder 15 is provided, which is attached to a component permanently attached to the vehicle, especially to a stub axle or a wheel carrier. Each pin guide 14 comprises a guide pin 16, by means of which the floating caliper 1 is supported on the brake holder 15 with a certain freedom of movement. According to the design shown in FIG. 1, each guide pin 16 is connected, especially screwed, to both caliper sections 5, 6 of the floating caliper 1 but held in the holder arm 17 with freedom to move. The brake holder 15 is designed essentially in the shape of a U with two retaining arms 17, which project into the frame-like floating caliper 2. In a variant, the brake holder 15 can also have a closed shape, which increases the rigidity of the holder even more. In detail, the brake holder 15, with its retaining arms 17 inside the frame-like structure of the floating caliper 1, forms a receiving opening for the brake pad. The inside surfaces of the opening directly support the axially inner brake pad 3 in the circumferential direction, whereas the outer surfaces absorb the circumferential braking forces of the floating caliper 1. As a result, the circumferential braking forces of the axially inner brake pad 3 which occur during braking are transmitted directly via the associated retaining arm 17 to the wheel carrier or stub axle permanently attached to the vehicle. The floating caliper 1 is not subjected to these circumferential braking forces of the inner brake pad 3. In contrast, the axially outer brake pad 4 is permanently attached to the caliper, and the circumferential braking forces which occur there are carried away via the floating caliper 1. For this purpose, the bridge sections 7 at the ends of the floating caliper 1 are supported tangentially against the outside surfaces of the retaining arms 17. This means that the pin guides 14 transmit little of any of the circumferential braking forces. The components of the pin guides 14 can therefore be made smaller or lighter in weight. Each of the two guide pins 16 extends through a retaining arm 17 and thus also project axially over the brake disk 2. The guide pins 16 also advantageously function as tension rods and are thus connected to the caliper sections 5, 6 of the floating caliper 1 to provide an additional increase in the rigidity of the floating caliper. Each of the guide pins 16 extends through the retaining arm 17 in close proximity to the brake pad support areas, so that the brake holder 16 can be designed in light-weight fashion with minimal use of material. In principle, the brake holder 16 can be designed as a separate part, which is then permanently attached to the vehicle, or it can be integrated directly into a component permanently attached to the vehicle such as a wheel carrier or a stub axle.

To protect the guide pin 16 from the effects of heat or other environmental influences, such as abraded material worn off from the brake pad and brake disk, it is helpful to provide these pins with a suitable surface coating or treatment. Advantageous coating variants which can be considered include, for example, diamond-like coatings, electroplated nickel coatings, ceramic coatings, and cermet coatings. Coatings of this type maintain the surface quality of the guide pins 16 for a long time and thus ensure the ease of movement of the floating caliper guide system.

An especially positive design feature of the floating-caliper disk brake 1 in comparison with known arrangements is that the brake pads 3, 4 can be utilized to a higher degree. This higher degree of utilization is achieved by the repositioning of the brake pads 3, 4 on the associated brake pad support areas as the wear on the brake disk and friction pads increases. In contrast to the situation of permanent support against the vehicle, the brake pads 3, 4, can thus be allowed to continue to wear down until they reach a certain minimal residual thickness without risk to the reliability of the support function. There is therefore no longer any need to increase the mass of the friction pad to allow for the wear of the brake disk, which has an advantageous effect on the necessary weight of the brake pad. This situation is present because the axially outer brake pad 4 is connected to the outer caliper section 6, preferably embedded in it, and travels concomitantly with the floating caliper 1 in the event of friction pad or brake disk wear without loss of brake pad support. When the friction pad or brake disk wears down, the axially inner brake pad 3 shifts relative to its support area on the brake holder 15. Under consideration of the wear of the friction pads on both sides and of the brake disk, the axial dimension of the support area on the brake holder 15 for the axially inner brake pad 3 must therefore to be large enough to ensure reliable tangential support of the brake pad even after the friction pad has undergone significant wear.

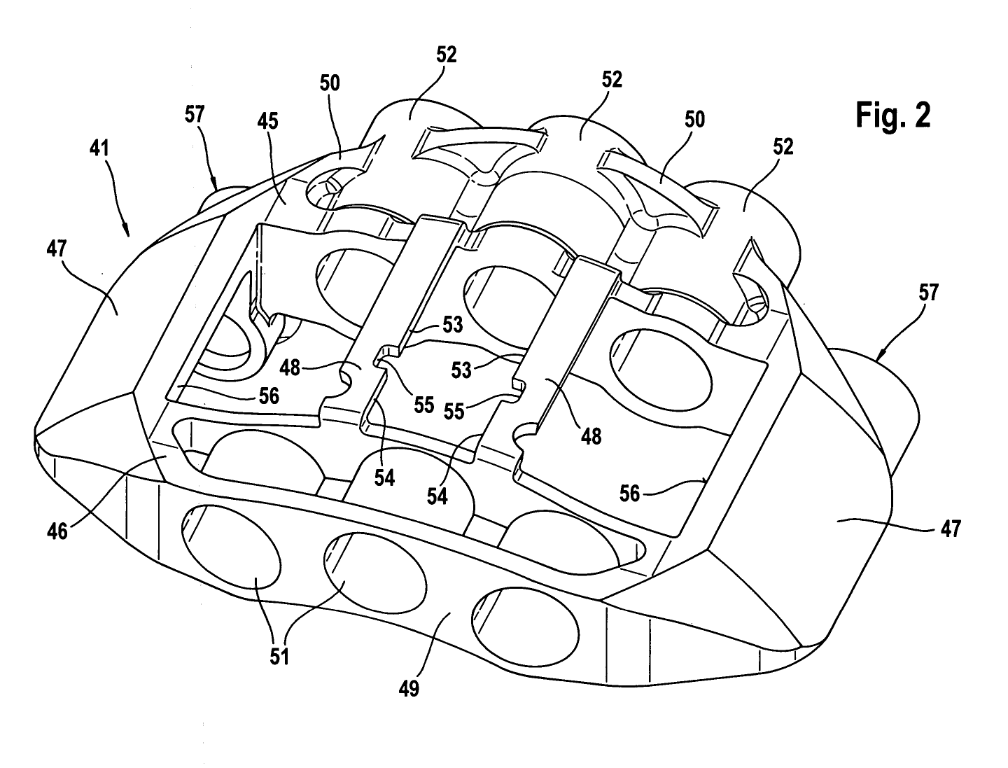

FIG. 2 illustrates a second embodiment of an inventive floating caliper 41, in which, in contrast to the previously described variant, both the axially inner and the axially outer brake pads are guided and supported in the frame-like floating caliper 41 in such a way that they are able to shift position to a certain extent. The brake pads (not shown) have appropriately shaped shoulders by which they are guided with freedom of axial movement on the central axial webs 48. For this purpose, guide surfaces 53, 54 for the inner and outer brake pads are formed on the webs 48; these surfaces are provided in particular with axial dimensions which guarantee reliable guidance of the brake pads regardless of how worn down they are. In addition, the webs 48 have openings 55, which allow the brake pads to be installed and removed. Specifically, during the installation process, the guide shoulders of the brake pads can be threaded via the openings 55 onto the webs 48.

To transmit the circumferential braking forces acting on the brake pads, furthermore, support surfaces 56 are formed on the inside of the bridge sections 47 at the circumferential ends. The shoulders at the circumferential ends of each of the brake pads (not shown) rest with freedom of axial movement against these support surfaces and are supported tangentially there. The support surfaces 56 in the floating caliper 41 are designed in such a way that they provide reliable support of the circumferential braking forces regardless of the state of wear of the brake pads and brake disk. In particular, the support surfaces 56 are long enough in the axial direction to reach the plane of the brake disk which cooperates with the brake pad and thus ensure proper support of even a worn brake pad. The direct support of the brake pads in the floating caliper 41 makes a brake holder according to FIG. 1 superfluous. Weight can thus be saved, which is advantageous.

The floating caliper 41 itself is supported with freedom of axial movement on a component permanently attached to the vehicle, especially a stub axle or a wheel carrier, by means of pin guides 57. The pin guides 57 act between the floating caliper 41 and the component attached to the vehicle and thus not only guide the axial movement of the floating caliper 41 but also simultaneously transmit the circumferential braking forces acting on the floating caliper 41. The pin guides 57 must transmit both the circumferential braking forces acting on the inner brake pad and the circumferential forces acting on the outer brake pad. The pin guides 57 preferably form a system comprising a load-bearing pin and a guide pin, where the first pin guide 57 with the load-bearing pin is suitable basically for transmitting the circumferential braking forces. The second pin guide 57 with the guide pin serves essentially to position the floating caliper 51 on the components attached to the vehicle. Specifically, the load-bearing and guide pins are connected directly to the component attached to the vehicle, i.e., the wheel carrier or stub axle, by means of screws, for example, and are held in the floating caliper 41 with a certain freedom of movement. As a result, the number of parts required for the floating caliper 41 with pin guides is reduced to a minimum. In addition, the contact surfaces inside the pin guides 57 required for the axial guidance of the floating caliper's movement are located, with respect to the vehicle, in an area which is easily accessible to a flow of cooling air. Accordingly, the operating temperature in the pin guides 57 is decreased to the desired level. The cooling air stream, furthermore, keeps the hot brake pad dust produced by wear away from the contact surfaces inside the pin guides 57.

Otherwise, essential design features of the embodiment according to FIG. 1, especially those pertaining to the lattice-like, light-weight structure, can also be carried over analogously to the floating caliper 41 according to FIG. 2. In principle, the inventive floating caliper disk brake offers the advantage over the known high-performance fixed-caliper brakes that the brake fluid and/or the entire brake is subject to less heating. In addition, an inventive floating-caliper disk brake with hydraulic actuation occupies less space than the fixed-caliper brake, because only half the number of brake pistons and thus half the number of sealing rings are used.

1-13. (canceled)

14. A floating-caliper disk brake for motor vehicles comprising:
a frame-like floating caliper (1, 41), which projects over a brake disk (2) and brake pads (3, 4), one of which is located on each side of the brake disk (2), the caliper being supported with freedom of movement by pin guides (14, 57) on a component (15) attached to the vehicle;
an inner caliper section (5, 45), which has at least one actuating device (12, 52); and
an outer caliper section (6, 46), which is connected to the inner caliper section (5, 45) by at least two bridge sections (7, 47), which project over the brake disk (2), wherein the caliper sections (5, 6; 45, 46) have a lattice-like, light-weight structure of high rigidity.

15. A floating-caliper disk brake according to claim 14, wherein at least an outer brake pad (4) is mounted immovably on the caliper, where the floating caliper (1, 41) is supported tangentially on the component (15) attached to the vehicle so that it can transmit circumferential braking forces.

16. A floating-caliper disk brake according to claim 14, wherein the actuating device (12, 52) comprises a movable actuating element (13), the guide length of which inside the actuating device (12, 52) is greater than the sum of the maximum wear values of both brake pads (3, 4) and the maximum wear value of both sides of the brake disk.

17. A floating-caliper disk brake according to claim 14, wherein at least one bridge section is designed as a central web (8, 48), which connects the caliper sections (5, 6; 45, 46) to each other in the area of the actuating device (12, 52).

18. A floating-caliper disk brake according to claim 14, wherein at least an outer caliper section (6, 46) has at least one cooling channel (11, 51) to allow a stream of cooling air to reach the outer brake pad (4).

19. A floating-caliper disk brake according to claim 14, wherein a brake holder (15) permanently attached to the vehicle, where the retaining arms (17) of the holder project into the frame-like floating caliper (1) and extend as far as the brake disk (2) only on the inside.

20. A floating-caliper disk brake according to claim 19, wherein the floating caliper (1) is supported tangentially against the retaining arms (17) of the brake holder (15) to allow the transmission of circumferential forces.

21. A floating-caliper disk brake according to claim 19, wherein the pin guide (14) has a guide pin (16), which is fastened to the caliper sections (5, 6) of the floating caliper (1) and is supported with freedom of movement in the brake holder (15).

22. A floating-caliper disk brake according to claim 21, wherein the guide pin (16) connects the two caliper sections (5, 6) to each other, thus acting as a tension rod.

23. A floating-caliper disk brake according to claim 21, wherein the guide pin (16) has a suitable, long-lasting surface coating or surface treatment to protect it from effects of heat and other environmental influences.

24. A floating-caliper disk brake according to claim 14, wherein at least one pin guide (57) has a load-bearing pin for transmitting circumferential forces.

25. A floating-caliper disk brake according to claim 24, wherein both brake pads are supported tangentially in the floating caliper (41) to allow the transmission of circumferential forces.

26. A floating-caliper disk brake according to claim 25, wherein at least the inner brake pad is guided with freedom of movement on at least one central web (48) of the floating caliper (41) regardless of the state of wear of the pad.
